(19) United States
(12) Patent Application Publication
(10) Pub. No.: US 2025/0043770 A1
(43) Pub. Date: Feb. 6, 2025

(54) WIND TURBINE

(71) Applicant: ALPHA 311 LIMITED, Faversham (GB)

(72) Inventors: John SANDERSON, Faversham (GB); Barry THOMPSON, Faversham (GB)

(73) Assignee: ALPHA 311 LIMITED, Faversham (GB)

(21) Appl. No.: 18/694,553

(22) PCT Filed: Sep. 23, 2022
(86) PCT No.: PCT/GB2022/052423

§ 371 Date: Mar. 22, 2024

(30) Foreign Application Priority Data
Sep. 23, 2021 (GB) 2113570.2

(51) Int. Cl. F03D 9/46; F03D 9/11; F03D 9/25; F03D 80/70; H02K 7/18

(52) U.S. Cl. CPC F03D 9/46; F03D 9/11; F03D 9/25; F03D 80/70; H02K 7/183; F05B 2220/706; F05B 2240/9113

(57) ABSTRACT

A wind turbine for attachment to an upstanding post, the turbine comprising a two-piece mounting bracket; a cylindrical sleeve coupled to the mounting bracket; a turbine blade apparatus rotationally coupled to the sleeve, wherein the axis of the sleeve defines the rotational axis of the turbine blade apparatus, the turbine blade apparatus comprising a lower blade support plate; an upper blade support plate; and two or more turbine blades located between the upper and lower blade supports, wherein a first end of each blade is coupled to the lower blade support and a second end of each blade is coupled to the upper blade support; and an electrical energy generator driven to rotate by the turbine blade apparatus, wherein the electrical energy generator generates electrical energy when the turbine blade apparatus rotates relative to the sleeve.

The present invention relates to a wind turbine, and in particular to a wind turbine that may be attached to a vertical post of an item of street furniture.

Wind turbines are well known. They tend to be mounted on bespoke masts which are located either on land or at sea during the installation process of the turbine. This increases the costs of both the wind turbine itself, as a bespoke mast must also be manufactured, and the costs of installation, and appropriate ground works/foundations must be prepared during the installation process.

It would thus be desirable to mount wind turbines on existing masts or posts.

Additionally, it is known that vehicles travelling on roads generate movement in the surrounding air. In other words, they generate their own “wind” or airflow as a result of their motion. The skilled person will appreciate that many road systems already include items of street furniture that are located adjacent to the roadways. Such items of street furniture typically include posts that support or carry signs, lights, cameras, etc at the top of the post.

Two-part wind turbines are known from WO2020/157219. The known turbines are coupled to either side of an upstanding post or mast. However, an alternative design is desired.

According to a first aspect of the invention, there is provided a wind turbine for attachment to an upstanding post, the turbine comprising a two-piece mounting bracket; a cylindrical sleeve coupled to the mounting bracket; a turbine blade apparatus rotationally coupled to the sleeve, wherein the axis of the sleeve defines the rotational axis of the turbine blade apparatus, the turbine blade apparatus comprising a lower blade support plate; an upper blade support plate; and two or more turbine blades located between the upper and lower blade supports, wherein a first end of each blade is coupled to the lower blade support and a second end of each blade is coupled to the upper blade support; and an electrical energy generator which is coupled to the turbine blade apparatus and driven by the turbine blade apparatus, wherein the electrical energy generator generates electrical energy when the turbine blade apparatus rotates relative to the sleeve.

The turbine blade apparatus is driven to rotate relative to the sleeve by both natural wind and by “wind” (i.e. moving airflow) which is generated by the movement of vehicles in close proximity to the post. It will be appreciated that the mounting bracket and the sleeve are fixed relative to post in use. Thus, the present invention seeks to provide an alternative apparatus to capture the energy stored in airflows generated by moving vehicles.

The sleeve is suitably fixed relative to the upstanding post. In other words, the sleeve may be stationary. Thus, the sleeve does not rotate relative to the post.

The provision of a two-part mounting bracket means that it can be attached or retrofitted to an existing mast or post, such as an existing post of an item of street furniture. Suitably, the sleeve and the turbine blade apparatus are pre-assembled prior to installation, such that the sleeve can simply be slid over the post and coupled to the two-part mounting bracket.

The skilled person will appreciate that rotatably coupling a turbine blade assembly to a sleeve, where the sleeve and the turbine blade assembly is not in a two-part form is easier than engineering a two-part sleeve and a two-part turbine blade assembly such that they can be coupled together in situ and have an acceptably smooth rotational action.

The two-piece mounting bracket is suitably coupled to the post in situ. For ease of installation, the two-piece mounting bracket may be a bottom mounting bracket. In other words, the bottom end of the sleeve (i.e. the lowermost end of the sleeve in use) may be coupled to the two-piece mounting bracket. In such embodiments, the wind turbine may include an upper locating apparatus which is coupled to the top or uppermost end of the sleeve. In such embodiments, the sleeve is evenly spaced about the post along its length. Thus, the sleeve is maintained in a concentric arrangement with the upstanding post.

In an embodiment of the invention, the lower blade support plate is rotationally coupled to a first portion of the sleeve; the upper blade support plate is rotationally coupled to a second portion of the sleeve; and the second portion of the sleeve is spaced upwardly from the first portion of the sleeve. By having both an upper and lower rotational coupling between the turbine blade apparatus and the sleeve, the rotation of the turbine blade apparatus relative to the sleeve is smoother and more controlled. Such an arrangement helps to maintain the turbine blade apparatus in a concentric arrangement about the sleeve.

In order to reduce or minimise friction between the turbine blade apparatus and the sleeve, the lower blade support plate may include a first bearing arrangement, and/or the upper blade support plate may include a second bearing arrangement, wherein the lower blade support plate and/or the upper blade support plate may each be rotationally coupled to the sleeve via the respective bearing arrangements.

In accordance with the invention, the or each bearing arrangement may include a rolling-element bearing, such as ball bearings or needle bearings (i.e. bearings which include spherical or needle-shaped rotating elements). The reduction in friction as a result of the or each bearing arrangement between the sleeve and the turbine blade apparatus increases the efficiency of the wind turbine.

In an embodiment of the invention, each turbine blade includes an inner blade edge that is parallel to rotational axis and radially spaced from rotational axis by a first distance; and an outer blade edge that is parallel to rotational axis and radially spaced from rotational axis by a second distance, wherein the second distance is greater than the first distance. In other words, each blade projects outwardly away from rotational axis.

Each blade may be aligned radially relative to the axis of rotation (e.g. a plane of the blade is oriented radially with respect to the axis of rotation) or an axis defined between the inner blade edge and the outer blade edge may be angled with respect to a radius from the rotational axis which includes the inner blade edge. For example, each blade may subtend an angle from the corresponding radius which is from 10° to 75°. In the context of the present invention, the term “each blade may subtend an angle . . . ” refers to an axis or a plane which is defined as passing through the inner blade edge and the outer blade edge, wherein the defined axis or plane of the blade intersects the respective radius at an angle. Such an arrangement may be advantageous when the wind direction is typically in a specific direction. For example, if the wind turbine is located adjacent to a road, the vehicles travelling along the road will cause air movement in a specific direction and the blades of the wind turbine may be angled to maximise the energy capture from this air movement. In an embodiment of the invention, the angle between the axis or plane of the blades and the corresponding radii from the axis of rotation may be from 20° to 60°, from 30° to 50° or from 30° to 45°.

In connection with the individual blades used in the turbine blade apparatus, these may be linear or curved. In other words, each blade may be curved from its inner blade edge to its outer blade edge, or it may be linear from its inner blade edge to its outer blade edge. Furthermore, each blade may have a transverse profile that has a variable thickness, for example, an aerofoil shape, in order to maximise the energy efficiency of the wind turbine.

In embodiments in which each turbine blade is curved from its inner blade edge to its outer blade edge, the radius of curvature may decrease from the inner blade edge to the outer blade edge.

In a further embodiment of the invention, the wind turbine further includes an upper cover, wherein the upper cover is coupled to the sleeve at a position above the upper blade support plate. The upper cover suitably defines a housing above the turbine blade apparatus. The cover is suitably a stationary cover, i.e., it is suitably rotationally fixed relative to the sleeve, which itself is suitably rotationally fixed relative to the post. The upper cover may protect the turbine blade apparatus to some extent from precipitation and atmospheric pollutants. It may also be used to house further components associated with the invention. For example, the housing may house one or more sensors associated with the performance of the wind turbine. Such sensors may sense the electrical energy generated by the generator, condition of the batteries, energy reserves within the batteries, atmospheric conditions, etc. Such sensors may be connected to a remote signal receiving station. Such a connection may be wired or it may be wireless, in which case, the housing may further house wireless communications equipment, such as a wireless transmitter that may utilise wireless data transmission protocols and operate via a wireless network, such as a mobile phone network.

Additionally or alternatively, the wind turbine may further include a lower cover, wherein the lower cover is coupled to the sleeve at a position below the lower blade support plate. As with the upper cover, the lower cover may be a stationary cover. It may also define a housing below the turbine blade apparatus. Where the lower cover defines a lower housing, the lower housing may contain one or more of the components associated with the wind turbine that are discussed above.

Moreover, the electrical energy generator may be carried by the upper cover or the lower cover. Thus, the electrical energy generator may be located within the upper or lower housing.

In connection with the electrical energy generator, the turbine blade apparatus may include a drive gear, drive pulley drive shaft or other known apparatus for driving a generator; and the electrical energy generator may include a driven gear, driven pulley, drive shaft coupling or other known apparatus for operatively coupling the generator to the turbine blade apparatus; wherein the turbine blade apparatus is operatively coupled to a rotor of the generator, whereby rotation of the turbine blade apparatus causes a corresponding rotation of the generator rotor. It will be appreciated that rotation of a rotor relative to a stator in an electrical energy generator generates electrical energy, which may be used and/or stored.

In an embodiment of the invention, the wind turbine includes a gearbox located between the turbine blade apparatus drive gear and the electrical energy generator driven gear. Alternatively, the rotor may be directly driven by the turbine blade apparatus. For example, the rotation of a component of the turbine blade apparatus may rotate the rotor on a 1:1 basis.

The electrical energy generator suitably includes an electrical output which is connected to an electrical energy storage assembly. The electrical energy storage assembly may be located locally to the wind turbine or it may be located remote from the wind turbine. The electrical energy storage assembly suitably comprises one or more rechargeable batteries. The or each battery may be located within a housing to protect them from environmental conditions, for example to protect them against precipitation, dust, etc. Furthermore, it is known that battery performance degrades in cold temperatures. Accordingly, the housing and/or the or each battery may be thermally insulated.

In addition to being connected to an electrical energy storage assembly, the electrical energy generator may include a second electrical output which may be connected to a powered device. For example, in embodiments in which the wind turbine is secured to a lamp post, the electrical energy generator may power the lamp(s) connected to the lamp post. Thus, the electrical energy needed to power the lamp(s) is suitably provided by the electrical energy generator and any surplus electrical energy may be transmitted to the electrical energy storage assembly.

Street furniture posts tend to have different external diameters if they are substantially cylindrical or tapered, or they may have different cross-sectional shapes, such as hexagonal or octagonal. In order to provide a single common mounting bracket component, the invention may further include an inner spacer or collar that is located between the post and the mounting bracket. For example, the mounting bracket may define a cylindrical inner surface. In such cases, one or more inner spacers or inner collar may be provided which each have a cylindrical outer surface that corresponds to the inner surface of the mounting bracket, but have different inwardly facing profiles (i.e. inwardly facing shapes and dimensions). In this way, the appropriate inner collar may be selected for the respective post and the mounting bracket is secured to the post via the inner collar.

According to a second aspect of the invention, there is provided an item of street furniture comprising an upstanding post and a wind turbine as defined anywhere herein in connection with the first aspect of the invention, wherein the mounting bracket is secured to the post and the sleeve is arranged coaxially with a longitudinal axis defined by the post.

In an embodiment of the second aspect of the invention, the upstanding post carries a powered device and the powered device is electrically connected to an output from the electrical energy generator. In this way, the powered device is powered by the wind turbine and does not need a separate energy supply. The powered device is suitably one or more lighting assemblies. However, the post may also carry one or more powered devices selected from a wireless communications component, a wireless data component, a camera, etc.

As noted above, street furniture posts tend to have different external diameters if they are substantially cylindrical or tapered, or they may have different cross-sectional shapes, such as hexagonal or octagonal. Accordingly, an outwardly facing surface of the post may have a geometric shape (for example cylindrical, conical, hexagonal, octagonal, etc.); the mounting bracket may include an inner spacer or collar located between the post and the mounting bracket; the inwardly facing shape of the spacer may correspond to the geometric shape of the outwardly facing surface of the post; and the outwardly facing surface of the spacer may be cylindrical.

According to a third aspect of the invention, there is provided an array of items of street furniture, wherein the array includes two or more items of street furniture as defined anywhere herein in connection with the second aspect of the invention; the array includes a common electrical energy storage assembly and each of the electrical energy generators includes an electrical output which is connected to the common electrical energy storage assembly. In this aspect of the invention, the common electrical energy storage assembly may be connected to a mains power network or other facility that requires electrical energy, for example, electric vehicle (EV) charging stations located adjacent to the road or at service stations.

The skilled person will appreciate that arrays of items of street furniture are currently powered by electrical energy that is distributed to the items of street furniture within the array from a distribution cabinet. Accordingly, there are electrical cables in place that connect the distribution cabinet to each of the items of street furniture within the array. This arrangement may be repurposed according to the invention. For example, the common electrical energy storage assembly may be located within the distribution cabinet. In such an arrangement, instead of electrical energy being transmitted from the cabinet to each of the items of street furniture, the surplus electrical energy generated by the wind turbines carried by each of the items of street furniture is transmitted to the distribution cabinet. Such an arrangement avoids the need to run new cables between the items of street furniture and the cabinet, as the existing cables may be used in reverse. Furthermore, the distribution cabinets tend to be connected to a mains electrical network. Accordingly, the electrical energy stored within the electrical energy storage assembly within the cabinet may be supplied to the mains electrical network using the existing electrical cables, but in reverse.

The skilled person will appreciate that the features described and defined in connection with the aspects of the invention and the embodiments thereof may be combined in any combination, regardless of whether the specific combination is expressly mentioned herein. Thus, all such combinations are considered to be made available to the skilled person.

An embodiment of the invention will now be described, by way of example only, with reference to the accompanying drawings in which:

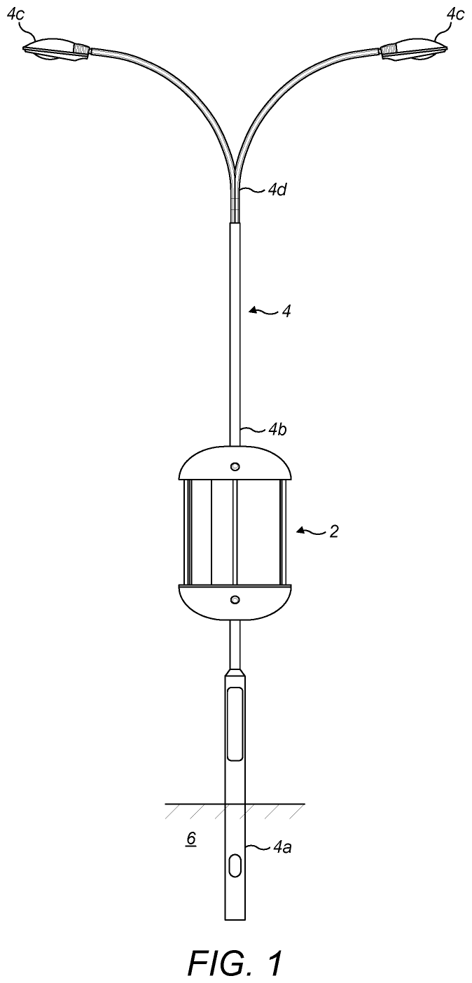

FIG. 1 shows a front elevational view of a wind turbine according to the first aspect of the invention coupled to a street lamp post;

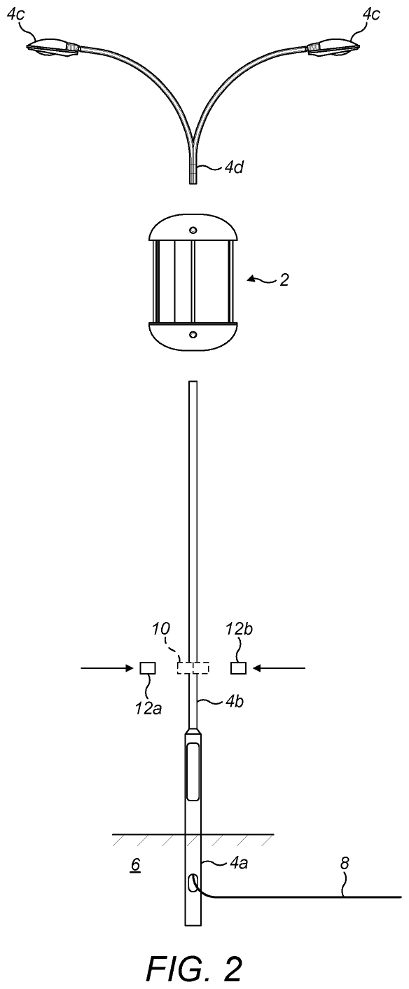

FIG. 2 shows an exploded view of the wind turbine shown in FIG. 1;

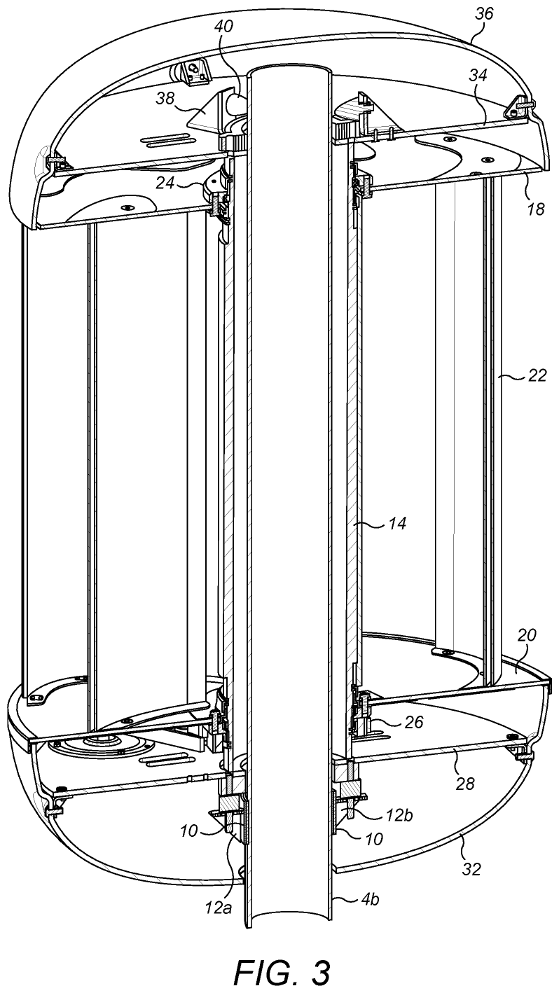

FIG. 3 shows a cross-sectional view of the wind turbine shown in FIG. 1;

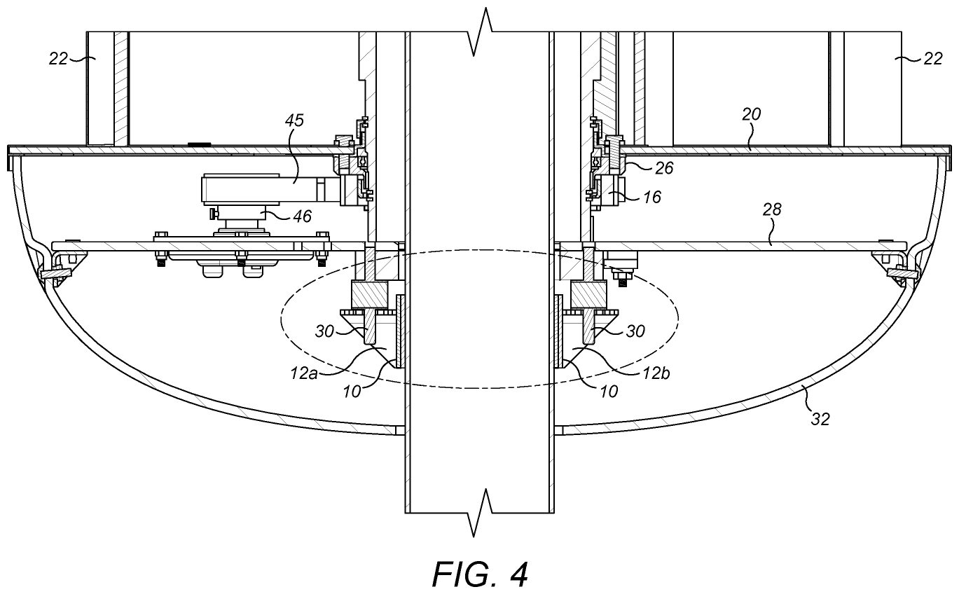

FIG. 4 shows a cross-sectional view through a bottom portion of the wind turbine shown in FIG. 3;

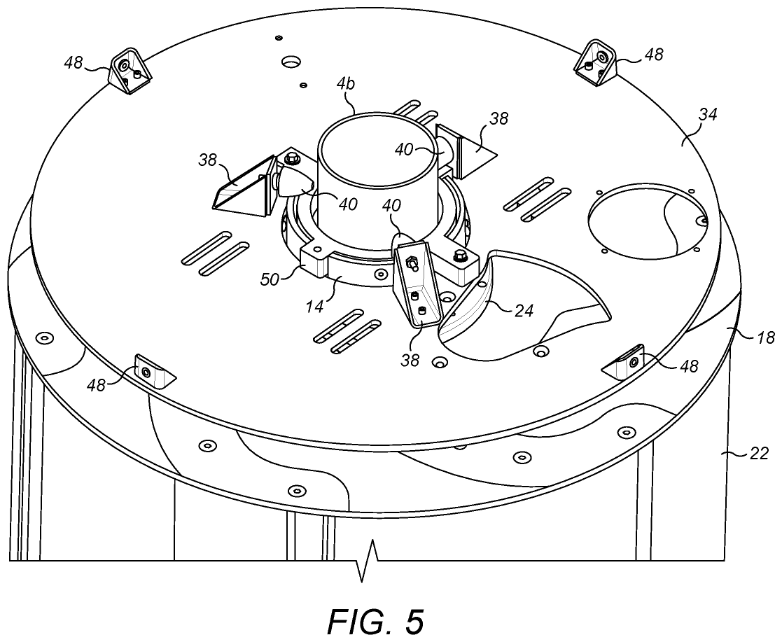

FIG. 5 shows a cross-sectional view through a top portion of the wind turbine shown in FIG. 3;

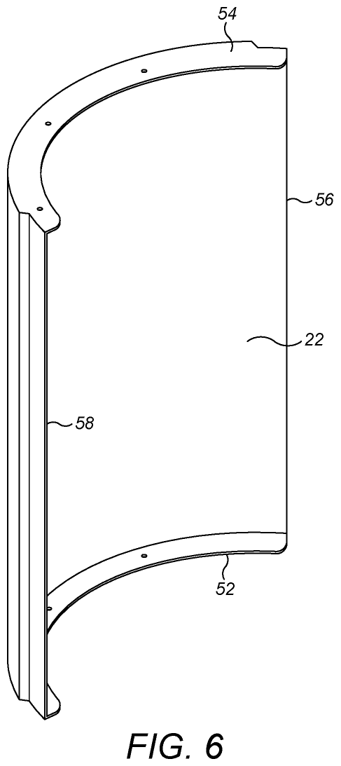

FIG. 6 shows a perspective view of a turbine blade which forms part of the wind turbine shown in FIG. 3;

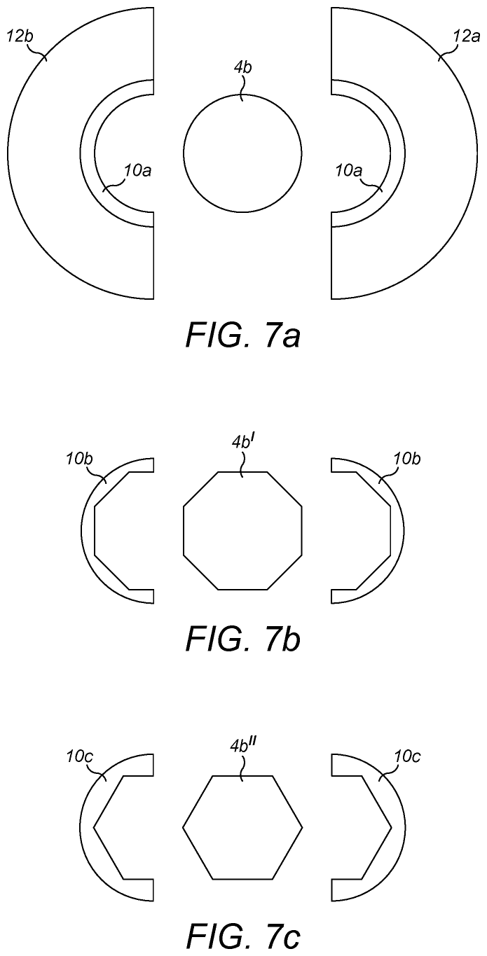

FIGS. 7a, 7b and 7c show horizontal cross sections through different embodiments of inner spacers located that form part of a two-piece mounting bracket which forms part of the wind turbine shown in FIG. 3;

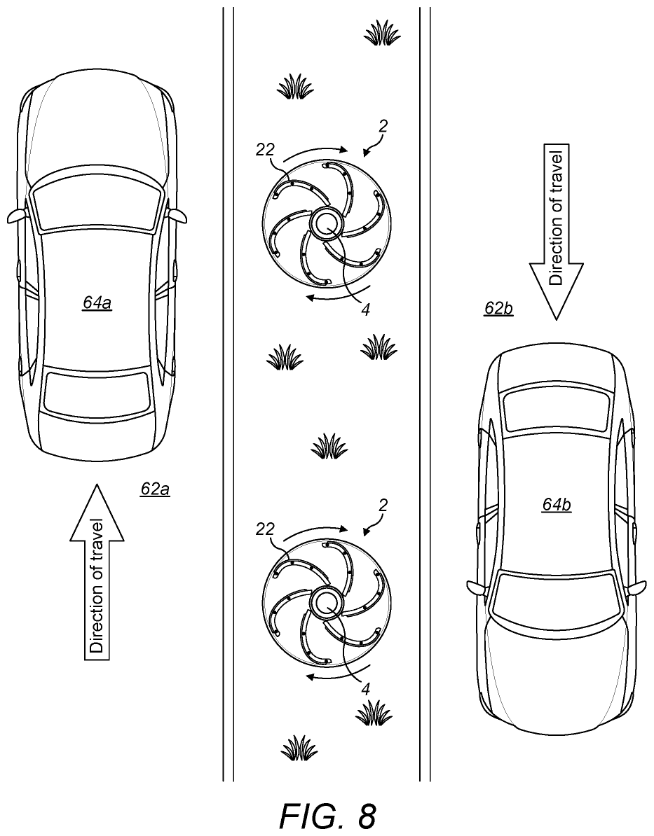

FIG. 8 shows a horizontal cross section through an array of street lamps located within a central reservation area of a road;

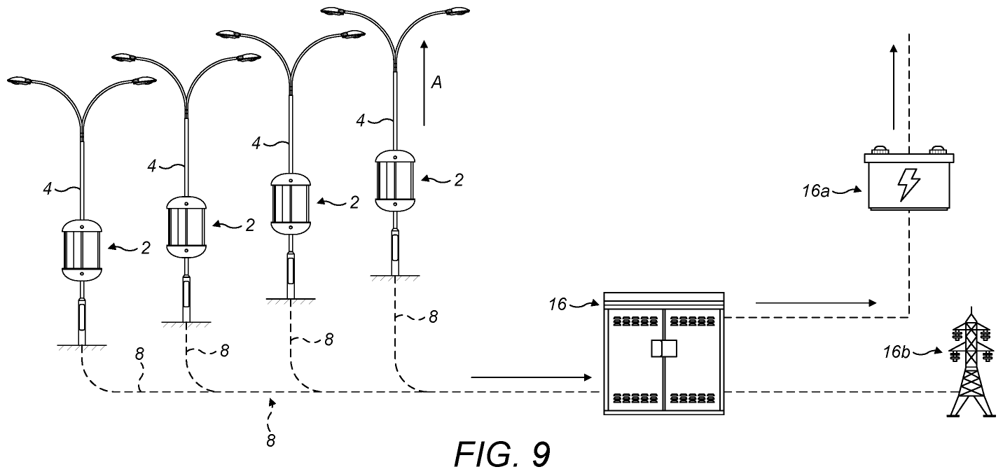

FIG. 9 shows a schematic representation of an array of street lamps connected to a common distribution cabinet; and

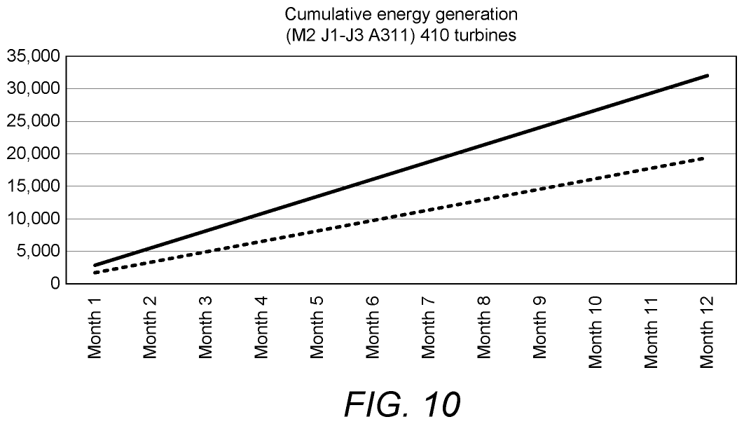

FIG. 10 shows a graph of the annual power generation that may be possible, where the Y axis indicates the generated power in MWh, the lower line is the power generated assuming a 30% efficiency and the upper line is the power generated assuming a 50% efficiency.

For the avoidance of doubt, the skilled person will appreciate that in this specification, the terms “up”, “down”, “front”, “rear”, “upper”, “lower”, “width”, etc. refer to the orientation of the components as found in the example when installed for normal use as shown in the Figures.

FIG. 1 shows a wind turbine 2 secured to a lamp post 4. The lamp post is a conventional arrangement in which a lower portion 4a of the lamp post 4 is located below the ground 6 and an upstanding portion 4b of the lamp post is upstanding from the ground 6. The lamp post 4 includes a pair of lamp arrangements 4c which are carried by an upper assembly 4d, which in turn is secured to the top of the upstanding portion 4b. As is common in the art of lamp posts, the upper assembly 4d is detachable from the upstanding portion 4b of the lamp post 4.

FIG. 2 shows an exploded view of the wind turbine 2 and the lamp post 4 shown in FIG. 1. FIG. 2 shows how the wind turbine 2 is secured to the lamp post 4. Initially, a two-piece mounting bracket 12a, 12b is secured to the upstanding portion 4b of the lamp post 4 via a two-piece inner spacer 10. The upper assembly 4d is then removed from the upstanding portion 4b of the lamp post 4 and a pre-assembled wind turbine 2 is slid over the upstanding portion 4b of the lamp post 4 and a sleeve 14 (shown in FIG. 3) of the wind turbine 2 is secured to the mounting bracket 12a, 12b. The wind turbine 2 is electrically connected to a cable 8 which previously supplied electrical power to the lamp arrangements from a common distribution cabinet 16 (shown in FIG. 9).

Once the wind turbine 2 has been secured to the post 4, the upper assembly 4d is re-attached to the upstanding portion 4b and an electrical output from the wind turbine 2 is also connected to the lamp arrangements 4c.

FIG. 3 shows a vertical cross-section through the wind turbine 2. The wind turbine 2 comprises a turbine blade apparatus formed by an upper blade support plate 18, a lower blade support plate 20 and a plurality of turbine blades 22 which are secured at one end to the upper blade support plate 18 and at their other end to the lower blade support plate 20.

The upper blade support plate 18 is rotationally coupled to the sleeve 14 via an upper bearing 24 which includes a plurality of ball bearings (not shown). Similarly, the lower blade support plate 20 is rotationally coupled to the sleeve 14 via a lower bearing 26 which also includes a plurality of ball bearings (not shown).

A lower cover mounting plate 28 is fixed to the mounting bracket 12a, 12b via bolts 30 (shown in more detail in FIG. 4). The bottom of the sleeve 14 is fixed to the lower cover mounting plate 28. Accordingly, the sleeve 14 is secured to the mounting bracket 12a, 12b via the lower cover mounting plate 28. To the lower cover mounting plate is secured a lower cover 32.

An upper cover mounting plate 34 is secured to the top of the sleeve 14 and an upper cover 36 is secured to the upper cover mounting plate 34. The upper cover mounting plate 34 carries three locating elements, each of which comprises a base 38 and a locating pin 40. The three locating pins 40 are equally spaced around the circumference of the upstanding portion 4b of the post 4 and these maintain the upper cover mounting plate 34 and the top of the sleeve 14 in a coaxial arrangement relative to the post 4.

As shown in FIG. 4, the lower cover mounting plate 28 carries an electrical energy generator 42, which is a conventional rotor and stator design, wherein rotation of the rotor relative to the stator generates electrical energy. Such technology is well known and need not be described in detail herein. The electrical energy generator 42 is connected to a drive belt pulley portion 44 of the lower bearing 26 via a drive belt 46.

An electrical output from the electrical energy generator 42 is connected to a power conditioner (not shown) which is located within the housing defined by the lower cover 32. The power conditioner conditions the electrical output from the electrical energy generator 42 to the desired voltage/current output. The conditioned electrical energy is then used to power the lamp arrangements 4c when controlled to do so by a lamp controller (not shown) and excess electrical energy is transmitted to an electrical energy storage apparatus via the cable 8.

As shown in FIG. 5, the upper cover mounting plate 34 is fixed to the top of the sleeve 14 by a bracket 50. The upper cover mounting plate 34 includes four upper cover mounting brackets 48 via which the upper cover 36 is fixed to the upper cover mounting plate 34.

FIG. 6 shows the shape of each turbine blade 22. Each turbine blade 22 includes a lower mounting element 52 and an upper mounting element 54. The turbine blades 22 are secured to the lower blade support plate 20 via the lower mounting element 52 and appropriate fixings, such as screws, bolts or rivets; and the turbine blades 22 are secured to the upper blade support plate 18 via the upper mounting element 54 and appropriate fixings.

Each blade includes an inner blade edge 56 which in use is located adjacent to the sleeve 14 and an outer blade edge 58. The blade 22 curves from its inner blade edge 56 to its outer blade edge 58 and the radius of curvatures decreases from the inner blade edge 56 to the outer blade edge 58.

FIGS. 7a, 7b and 7c show plan views of the two-piece mounting bracket 12a, 12b and different embodiments of the two-piece inner spacer 10a, 10b, 10c. As shown in FIG. 7a, the upper portion 4b of the post 4 has a circular cross-section. Accordingly, for such posts 4, each of the two-piece inner spacers 10a are semi-cylindrical. As shown in FIG. 7b, the upper portion 4b′ of the post 4 has an octagonal cross-section. Accordingly, for such posts 4, the two-piece inner spacers 10b together define an octagonal inwardly facing surface which corresponds to the outwardly facing octagonal surface of the upper portion 4b′; and the two-piece inner spacers 10b together define a cylindrical outer surface which corresponds to the cylindrical inwardly facing surface defined by the two-piece mounting bracket 12a, 12b. In this way, the two-piece inner spacer 10b allows the mounting bracket 12a, 12b to be secured to an upper portion 4b′ of a post 4 which has an octagonal cross-sectional shape. As shown in FIG. 7c, the upper portion 4b″ of the post 4 has a hexagonal cross-section. Accordingly, for such posts 4, the two-piece inner spacers 10c together define a hexagonal inwardly facing surface which corresponds to the outwardly facing hexagonal surface of the upper portion 4b″; and the two-piece inner spacers 10c together define a cylindrical outer surface which corresponds to the cylindrical inwardly facing surface defined by the two-piece mounting bracket 12a, 12b. In this way, the two-piece inner spacer 10c allows the mounting bracket 12a, 12b to be secured to an upper portion 4b″ of a post 4 which has a hexagonal cross-sectional shape.

It will be appreciated that although not shown in FIGS. 7b and 7c, the same two-piece mounting bracket 12a, 12b as shown in FIG. 7a is used in association with the respective inner spacer 10b, 10c.

FIG. 8 shows the location of an array of two wind turbine arrangements 2, wherein the two wind turbine arrangements are located on adjacent street lamp posts 4 which are in turn located in a central reservation portion 60 of a road system comprising a road 62a, 62b each side of the central reservation 60. The arrows in FIG. 8 indicate the direction of travel of vehicles 64a, 64b using the roads 62a, 62b and the direction of rotation of the turbine blade apparatus.

The skilled person will appreciate that the movement of air generated by the vehicles 64a, 64b moving along their respective roads 62a, 62b causes the rotation of the turbine blade apparatus, in addition to the action of the prevailing wind on the turbine blades 22.

It will be noted from FIG. 8 that the blades 22 located within the turbine blade apparatus are angled with respect to radii from the axis of rotation of the turbine blade apparatus. In connection with this, the angle of rotation is calculated by assigning a linear axis which includes the inner blade edge 56 and the outer blade edge 58 and determining the angle subtended by this axis to a radius which includes the inner blade edge 56. This angling of the blades 22 increases the efficiency with which the turbine blade assemblies are rotated by the air movements caused by passing vehicles 64a, 64b.

FIG. 9 shows a schematic representation of an array of lamp posts 4 which include wind turbines 2, where the output cables 8 from each of the wind turbines 2 are connected to a common distribution cabinet 16. As noted above, the common distribution cabinets 16 conventionally supply electrical energy to each of the lamp posts 4 to power the lamp arrangements 4c. However, in the context of the present invention, the flow of electrical energy is reversed and power flows from the wind turbines 2 carried by the lamp posts 4 to the common distribution cabinet 16. The common distribution cabinet 16 includes power conditioning components (not shown) which convert the incoming electrical power to the desired power output, sensors to sense the local demand for electrical energy and switches to transmit the electrical energy output from the distribution cabinet 16 to the desired output destination, for example, a local energy storage apparatus 16a for later use to satisfy local demand or to a national electrical grid 16b.

In addition to the output from the wind turbines 2 to the distribution cabinet 16, the wind turbines include a second power output (shown by arrow A in FIG. 9) which transmits power generated by the wind turbine 2 to the lamp arrangements 4c carried by the lamppost 4.

The skilled person will appreciate that if the wind turbines are unable to power the lamp arrangements 4c at a given time, power from a local energy storage apparatus 16a may be transmitted back to the distribution cabinet 16 and be transmitted back to the lamp posts 4 to power the lamp arrangements 4c from the stored electrical energy.

Studies have established a correlation between vehicle speed and the associated wind speed generated by the movement of the vehicle. These are shown in the following Tables:

TABLE 1
Wind velocity generated by an average-sized car

| MPH | M/S | Wind Velocity(m/s) |
|---|---|---|
| 50 | 22.4 | 5.4 |
| 60 | 26.8 | 5.9 |
| 70 | 31.2 | 6 |

TABLE 2
Wind velocity generated by a large car, such as an MPV or SUV

| MPH | M/S | Wind Velocity (m/s) |
|---|---|---|
| 50 | 22.4 | 5.8 |
| 60 | 26.8 | 6.22 |
| 70 | 31.2 | 6.78 |

TABLE 3
Wind velocity generated by a large vehicle,
such as a bus or HGV (lorry)

| MPH | M/S | Wind Velocity(m/s) |
|---|---|---|
| 50 | 22.4 | 7.77 |
| 60 | 26.8 | 8.22 |
| 70 | 31.2 | 8.55 |

From the above average generated wind velocities, it is possible to estimate the power that may be generated by the wind turbines of the present invention according to the following equation:

Power=constant×(air velocity)³×air density×collection area

The wind turbine shown in the Figures and described hereinabove had a collection area of 94.24 m², the constant is 0.5, the air density at sea level is 1.875 and the generated wind velocity is based on an average-sized car travelling at 60 MPH or 26.9 m/s. Accordingly:

$$Power = 0.5 \times {( 5.9 )}^{3} \times 1.875 \times 94.24$$

$$Power = 18.15 kW .$$

In other words, working at 100% efficiency, each wind turbine can generate 435.49 kWh per day. Allowing for less than 100% efficiency, each wind turbine could generate 217.74 kWh at 50% efficiency or 130.65 kWh at 30% efficiency.

The above calculation assumes an installation at the side of a single carriageway. However, if each wind turbine is installed between opposing carriageways as shown in FIG. 8, the effective wind speed that impacts the turbine blade assembly is doubled. This would generate a power output from the wind turbine of 145.16 kW, as the generated wind velocity is cubed, so a doubling of the generated wind velocity results in an 8-fold increase in power generated.

This results in a daily (24 hour) power output of 3.48 MWh. Again, assuming less than 100% efficiency, this would equate to a daily power output of 1.74 MWh at 50% efficiency or 1.05 MWh at 30% efficiency.

In order to validate the average speed assumptions, data was collected for traffic flow between Junctions 1&2 (both Eastbound and Westbound) of the M2 motorway in the UK and between Junctions 2&3 (both Eastbound and Westbound) of the M2 motorway in the UK.

The data showed the following average vehicle speeds across all four of the measured areas:

| Time | Average vehicle speed (m/s) |
|---|---|
| 0700 | 28.77 |
| 1200 | 30.01 |
| 1800 | 29.58 |
| 2200 | 23.33 |

This indicates that the assumed speed for the above calculations (26.8 m/s) is a reasonable assumption.

There are 410 street lamps between Junctions 1 and 3 of the M2 motorway. Assuming that a wind turbine according to the invention is installed on each of these street lamps, the graph shown in FIG. 10 indicates the annual power generation that may be possible, where the Y axis indicates the generated power in MWh, the lower line is the power generated assuming a 30% efficiency and the upper line is the power generated assuming a 50% efficiency.

Accordingly, over the course of a year, the 410 wind turbines could generate 32.1 GWh at 50% efficiency or 19.2 GWh at 30% efficiency.

1. A wind turbine for attachment to an upstanding post, the turbine comprising a two-piece mounting bracket; a cylindrical sleeve coupled to the mounting bracket; a turbine blade apparatus rotationally coupled to the sleeve, wherein the axis of the sleeve defines the rotational axis of the turbine blade apparatus, the turbine blade apparatus comprising a lower blade support plate; an upper blade support plate; and two or more turbine blades located between the upper and lower blade supports, wherein a first end of each blade is coupled to the lower blade support and a second end of each blade is coupled to the upper blade support; and an electrical energy generator which is coupled to and driven by the turbine blade apparatus, wherein the electrical energy generator generates electrical energy when the turbine blade apparatus rotates relative to the sleeve.

2. A wind turbine according to claim 1, wherein the lower blade support plate is rotationally coupled to a first portion of the sleeve; the upper blade support plate is rotationally coupled to a second portion of the sleeve; and the second portion of the sleeve is spaced upwardly from the first portion of the sleeve.

3. A wind turbine according to claim 2, wherein the lower blade support plate includes a first bearing arrangement, and the upper blade support plate includes a second bearing arrangement, wherein the lower blade support plate and the upper blade support plate are each rotationally coupled to the sleeve via the respective bearing arrangements.

4. A wind turbine according to claim 3, wherein each bearing arrangement includes a rolling-element bearing.

5. A wind turbine according to claim 1, wherein each blade includes an inner blade edge that is parallel to rotational axis and radially spaced from rotational axis by a first distance; and an outer blade edge that is parallel to rotational axis and radially spaced from rotational axis by a second distance, wherein the second distance is greater than the first distance.

6. A wind turbine according to claim 5, wherein an axis defined between the inner blade edge and the outer blade edge is angled with respect to a radius from the rotational axis which includes the inner blade edge.

7. A wind turbine according to claim 5, wherein each turbine blade is substantially planar.

8. A wind turbine according to claim 5, wherein each turbine blade is curved from its inner blade edge to its outer blade edge.

9. A wind turbine according to claim 8, wherein the radius of curvature decreases from the inner blade edge to the outer blade edge.

10. A wind turbine according to claim 1, wherein the wind turbine further includes an upper cover, wherein the upper cover is coupled to the sleeve at a position above the upper blade support plate.

11. A wind turbine according to claim 10, wherein the wind turbine further includes a lower cover, wherein the lower cover is coupled to the sleeve at a position below the lower blade support plate.

12. A wind turbine according to claim 11, wherein the electrical energy generator is carried by the upper cover or the lower cover.

13. A wind turbine according to claim 1, wherein the turbine blade apparatus includes a drive gear, the electrical energy generator includes a driven gear coupled to a rotor and the drive gear is operatively coupled to the driven gear whereby rotation of the drive gear causes a corresponding rotation of the driven gear.

14. A wind turbine according to claim 13, wherein the turbine includes a gearbox located between the turbine blade apparatus drive gear and the electrical energy generator driven gear.

15. A wind turbine according to claim 1, wherein the electrical generator includes an electrical output connected to an electrical energy storage assembly.

16. A wind turbine according to claim 15, wherein the electrical energy storage assembly comprises one or more rechargeable batteries.

17. A wind turbine according to claim 15, wherein the electrical generator includes a second electrical output which is connected to a powered device.

18. An item of street furniture comprising an upstanding post and a wind turbine; wherein the wind turbine comprises a two-piece mounting bracket; a cylindrical sleeve coupled to the mounting bracket; a turbine blade apparatus rotationally coupled to the sleeve, wherein the axis of the sleeve defines the rotational axis of the turbine blade apparatus, the turbine blade apparatus comprising a lower blade support plate; an upper blade support plate; and two or more turbine blades located between the upper and lower blade supports, wherein a first end of each blade is coupled to the lower blade support and a second end of each blade is coupled to the upper blade support; an electrical energy generator which is coupled to and driven by the turbine blade apparatus, wherein the electrical energy generator generates electrical energy when the turbine blade apparatus rotates relative to the sleeve; and wherein the mounting bracket is secured to the post and the sleeve is arranged coaxially with a longitudinal axis defined by the post.

19. An item of street furniture according to claim 18, wherein the post carries a powered device and the powered device is electrically connected to an output from the electrical energy generator.

20. An item of street furniture according to claim 18, wherein an outwardly facing surface of the post has a geometric shape; the mounting bracket includes an inner spacer located between the post and the mounting bracket; the internal shape of the spacer corresponds to the geometric shape of the outwardly facing surface of the post; and the outwardly facing surface of the spacer is cylindrical.

21. An array of items of street furniture, wherein the array includes two or more items of street furniture as defined in claim 18; the array includes a common electrical energy storage assembly and each of the electrical energy generators includes an electrical output which is connected to the common electrical energy storage assembly.
